(19) United States
(12) Patent Application Publication
(10) Pub. No.: US 2017/0342743 A1
(43) Pub. Date: Nov. 30, 2017

(54) SHOOT BOLT ASSEMBLY

(71) Applicant: RMD INDUSTRIES PTY LTD, Sunshine, Victoria (AU)

(72) Inventors: Stylianos Pelekanos, Sunshine, VIC (AU); Stephanie Winkler, Sunshine, VIC (AU)

(73) Assignee: Schlage Lock Company LLC, Camel, IN (US)

(21) Appl. No.: 15/535,565

(22) PCT Filed: Dec. 18, 2014
(86) PCT No.: PCT/AU2014/050435

§ 371 Date: Jun. 13, 2017

(51) Int. Cl. E05B 65/00; E05C 9/04; E05D 5/04; E05D 15/26; E06B 3/70; E06B 3/92

(52) U.S. Cl. CPC E05B 65/0085; E05D 5/04; E05D 15/26; E05C 9/04; E06B 3/922; E06B 2003/7046; E05Y 2600/626

(57) ABSTRACT

The invention relates to a shoot boll assembly for mounting in a groove formed in a side edge of a panel, the assembly including a handle mechanism, a shoot bolt and a rod to connect the handle mechanism to the shoot bolt so that, actuation of the handle mechanism causes the shoot bolt to extend and retract from a top or bottom edge of the panel, wherein the assembly includes a hinge block arranged to fit in the groove, the hinge block having a deck with attachment holes for a hinge and fixing platforms that secure the block to a base of the groove, wherein a passage is provided beneath the deck and platforms for the rod to pass through. The invention also relates to a hinge block for the shoot bolt assembly, a folding panel system and a method of constructing a panel.

### FIELD

The present invention relates to a shoot bolt assembly for use in a folding panel system.

### BACKGROUND

A known folding panel system includes folding panels to close an interior from an exterior of, say, a house or building. The panels are supported by a series of pivot sets and rollers between an overhead track and an elongate channel that extends beneath the panels. The elongate channel is defined by an extruded profile that forms a sill of the system.

The panels include an intermediate panel that is coupled to an adjacent pivot panel by a set of hinges. A shoot bolt assembly is used to lock the intermediate panel in a closed condition, where top and bottom edges of the intermediate panel are secured relative to keepers that are in fixed positions with respect to the guide track and channel.

The shoot bolt assembly is mounted into a side edge of the intermediate panel and includes two shoot bolts coupled to a lock body by elongate rods. The rods, lock body and shoot bolts are recessed into a groove that is machined into the side edge of the panel. The shoot bolts are housed in inserts that are screwed into opposite ends of the groove. The rods are housed internally of cover strips that extend along the edge of the panel, either side of the lock body.

An actuating handle and a lock barrel couple to the lock body from an interior face of the panel. The set of hinges have hinge knuckles that are also positioned adjacent the interior face of the panel.

Screws are used to attach the hinges to the intermediate panel, through the cover strips and into the back of the groove. Careful positioning of the hinges over the cover strips is required to avoid fouling operation of the rods.

The exterior surface of the panel is used as a datum point to calculate the relative position of the groove and lock body in the side edge of the panel. If a different width panel is used, the position of the groove and lock body with respect to the exterior surface will remain the same but different components such as a handle, lock barrel and hinges will be needed since all those components arc mounted relative to the interior surface.

### OBJECT

The present invention seeks to provide an alternative shoot bolt assembly, folding panel system and/or method of construction.

### SUMMARY

In accordance with the invention, there is provided a shoot bolt assembly for mounting in a groove formed, in a side edge of a panel, the assembly including a handle mechanism, a shoot bolt and a rod to connect the handle mechanism to the shoot bolt so that actuation of the handle mechanism causes the shoot, bolt to extend and retract from a top or bottom edge of the panel, wherein the assembly includes a hinge block arranged to fit in the groove, the hinge block having a deck with attachment holes for a hinge and fixing platforms that secure the block to a base of the groove, wherein a passage is provided beneath the deck and platforms for the rod to pass through.

Preferably, the block includes side supports that distance the deck from the platforms.

Preferably, the platforms bridge between the side supports and extend from either end of the deck, to receive a respective fastener to fix the platforms to the base of the groove.

Alternatively, the platforms are located between the ends of the block and the deck has openings to allow access to the platforms, in order for the platforms to receive associated fasteners for fixing the block to the has of the groove.

Preferably, the assembly further includes clips that are fastened into the groove either side of the block to ensure alignment of the rod is maintained through the groove.

Preferably, the clips include resilient fingers to hold a cover strip.

Preferably, the assembly further includes multiple blocks arranged along the groove at locations where hinges are positioned to connect the panel to an adjacent pivot panel.

Preferably, the assembly further includes a second shoot bolt and an associated rod for attachment to the handle mechanism such that operation of the handle mechanism causes the first and second shoot bolts to simultaneously extend and retract from the respective top and bottom edges of the panel.

In another aspect, there is provided a hinge block for the shoot bolt assembly, as described above, including a deck with attachment holes for a hinge and fixing platforms to mount the block in a groove in a side edge of a panel, with the deck in spaced relation from a base of the groove so as to define a passage beneath the deck.

Preferably, the platforms bridge between side supports of the block and extend from either end of the deck, each platform having an aperture to receive a fastener to secure the block in the groove.

Alternatively, the platforms are located between ends of the block and the deck has openings to allow access to the platforms, in order for the platforms to receive associated fasteners for fixing the block to the base of the groove.

Preferably, the block includes shoulders that project above a level of the dock in order to locate a hinge over the attachment holes.

A folding panel system including a series of panels mounted between an overhead track and a sill, wherein two of the panels are hinged together and the shoot bolt assembly, as described above, is mounted in a side edge of one of the panels.

In another aspect, there is provided a method of constructing a panel with a grooved formed in a side edge of the panel and a shoot bolt assembly, as described above, mounted in the groove including:

mounting the handle mechanism in a rebate formed in rebase of the groove;

fixing the hinge block in the groove so the deck is substantially level with the side edge;

inserting a rod through the passage beneath the deck;

attaching ends of the rod to the handle mechanism and the shoot bolt.

Preferably, the method further includes attaching a hinge to the hinge block by screwing fasteners into the deck.

Preferably, multiple hinge blocks are fixed along the groove, at locations where hinges are positioned to connect the panel to an adjacent panel.

Preferably, the method further includes inserting a second rod in the channel, from an opposite side of the handle mechanism, passing the second rod through one or more of the multiple hinge blocks and attaching ends of the second rod to the handle mechanism and a second shoot bolt.

Preferably, clips are fixed into the groove, either side of the cleats in order to maintain alignment of the rods in the groove.

Preferably, cover strips are fitted over the groove and held in place by resilient fingers of the clips.

Preferably, an interior face of the panel is used as a datum point for determining the relative position of the shoot bolt assembly.

### BRIEF DESCRIPTION OF THE DRAWINGS

The invention is more fully described, by way of non-limiting example only, with reference to the accompanying drawings, in which:

FIG. 1 is an exploded perspective view of a shoot bolt assembly mounted in an edge of a panel;

FIG. 2 is a perspective view showing a handle mechanism being inserted in the edge of the panel;

FIG. 3 is a perspective view showing hinge blocks being inserted in the edge of the panel;

FIG. 3A illustrates another example of a hinge block;

FIG. 4 is a perspective view of a series of clips being mounted in the edge of the panel;

FIG. 5 is a perspective view of end cleats being introduced into the panel;

FIG. 6 is a perspective view of rods being fitted into the panel;

FIG. 7 illustrates the rods being connected to shoot bolts of the assembly;

FIG. 8 illustrates a handle and lock barrel being connected to the handle mechanism;

FIG. 9 is a perspective view of cover strips fitted over the edge of the panel;

FIG. 10 is a perspective view showing hinges being mounted to the hinge blocks;

FIG. 11a is a top view of the panel and shoot bolt assembly with a non-mortise hinge;

FIG. 11b is a side view of the non-mortise hinge mounted to the panel;

FIG. 11c is a cross sectional view, along the line A-A shown in FIG. 11b;

FIG. 12a is a top view of the panel and shoot bolt assembly with a mortise hinge;

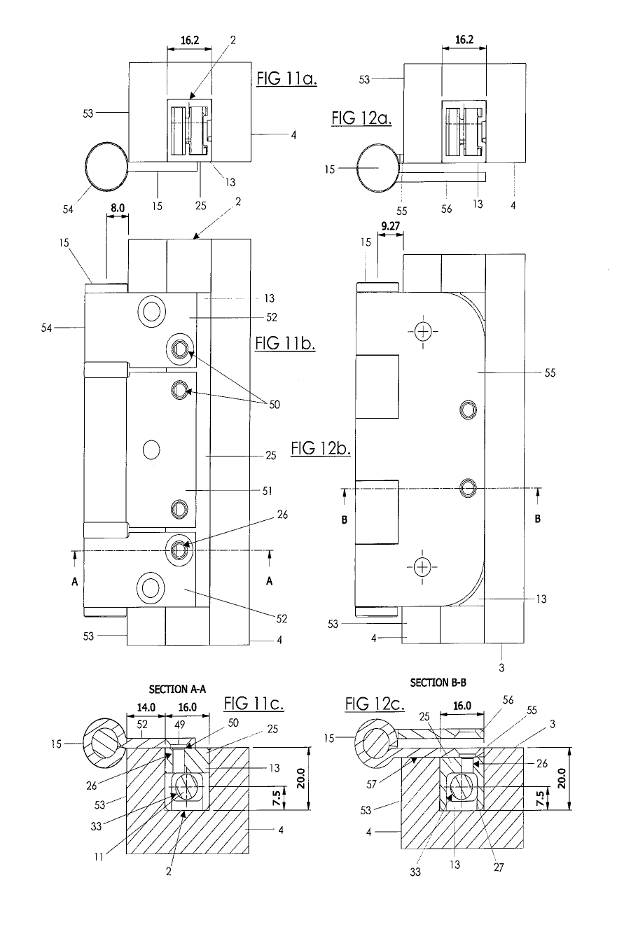

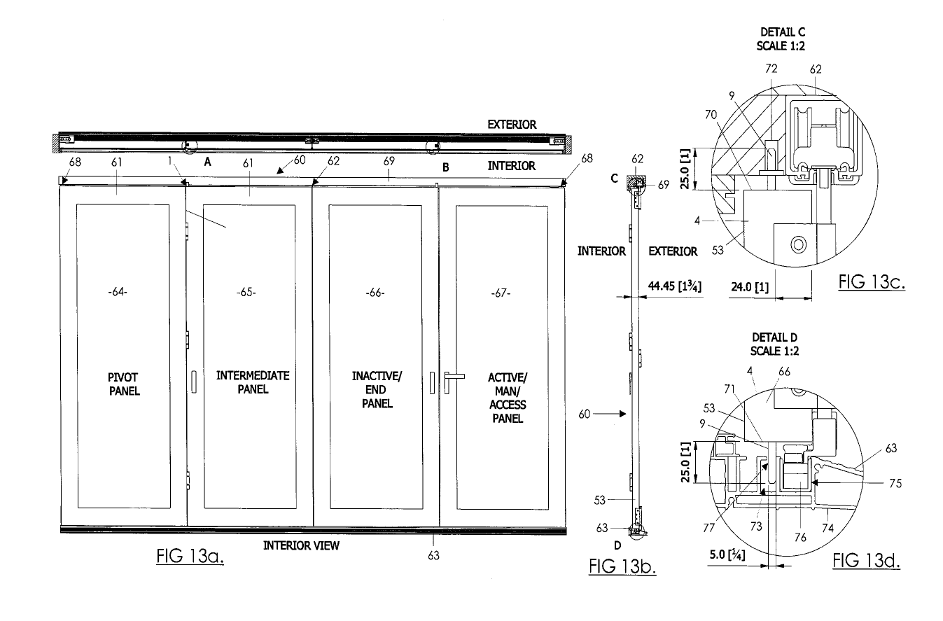

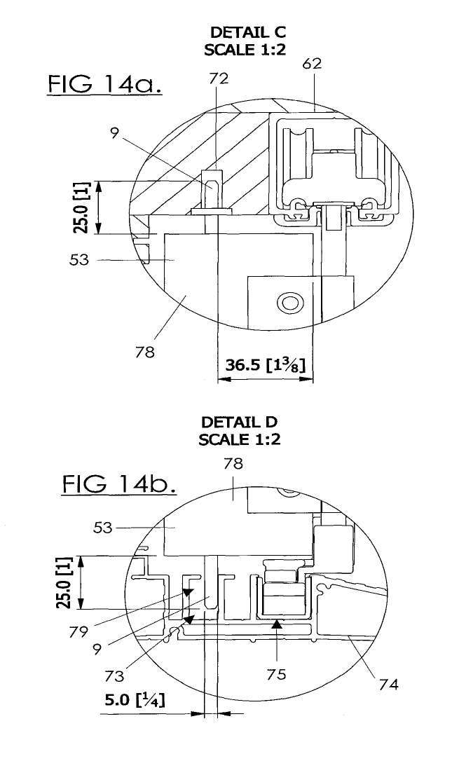

FIG. 11b is a side view of the mortise hinge mounted to the panel;

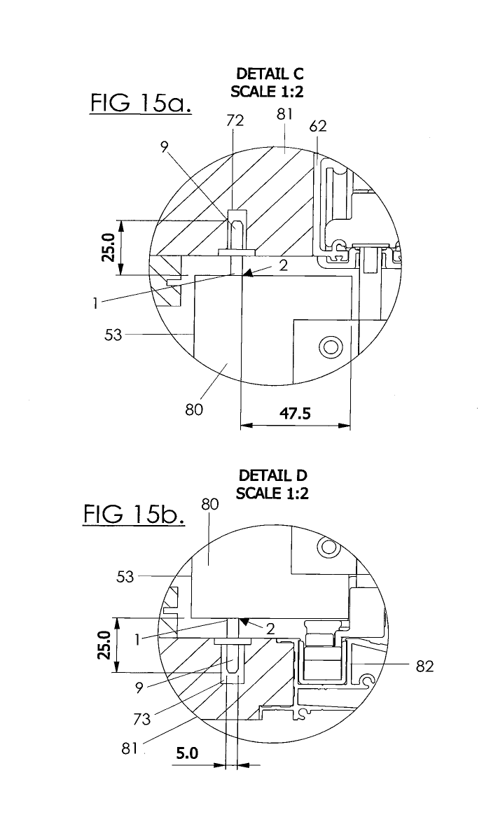

FIG. 12c is a cross-sectional view, along the line B-B shown in FIG. 12b;

FIG. 13a is a view of an interior side of a panel system;

FIG. 13b is an end view of the system;

FIG. 13c is an enlarged section C, shown in FIG. 13b;

FIG. 13d is an enlarged section D, shown in FIG. 13b;

FIG. 14a is view similar to FIG. 13c, with a panel of increased thickness;

FIG. 14b is a view similar to FIG. 13d, showing the panel of increased thickness;

FIG. 15a is a view similar to FIG. 14a, showing a panel of greater thickness; and

FIG. 15b is a view similar to FIG. 14b, showing the panel of greater thickness.

### DETAILED DESCRIPTION

Throughout the following description, like references will be used to denote, like parts.

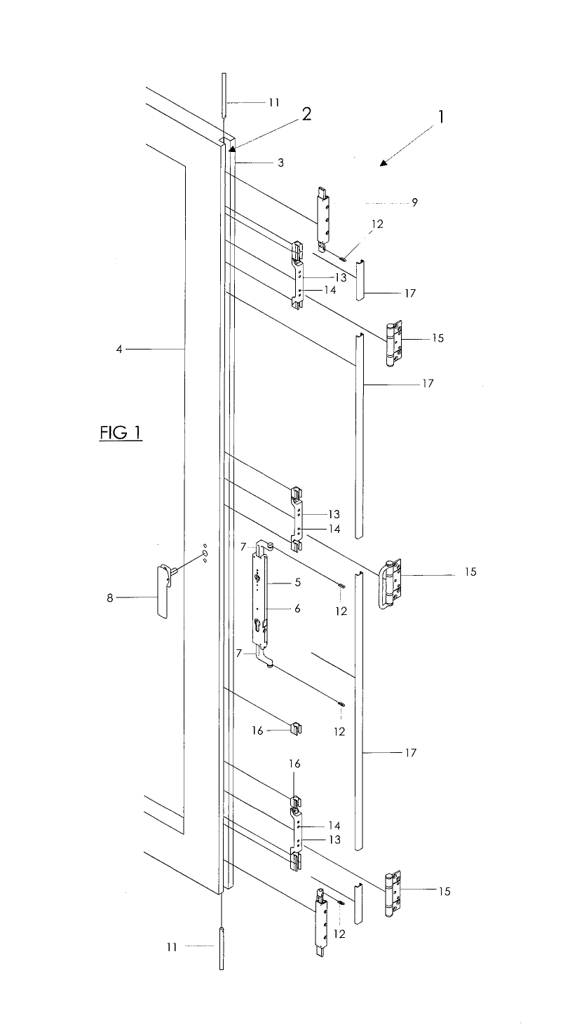

FIG. 1 shows a shoot bolt assembly 1 arranged to be mounted in a groove 2 formed in a side edge 3 of a folding door panel 4.

The assembly 1 includes a handle mechanism 5 that has a body 6 and linkages 7 that move in and out of the body 6 under action of a handle 8, to drive shoot bolts 9 in and out of respective end cleats 10. The shoot bolts 9 are connected to the linkages 7 via elongate rods 11 that are attached to the respective linkage 7 and shoot bolt 9 via connectors 12.

Hinge blocks 13 are arranged intermediate the body 6 and the shoot bolts 9. The hinge blocks 13 include locating holes 14 for hinges 15 to attach to.

A series of guide clips 16 are provided along the length of the groove 2 to maintain alignment of the rods 11.

Cover strips 17 are arranged to extend between the blocks 13 and a further cover strip 17 is fitted over the handle mechanism 5. The cover strips 17 are held in place by the clips 16.

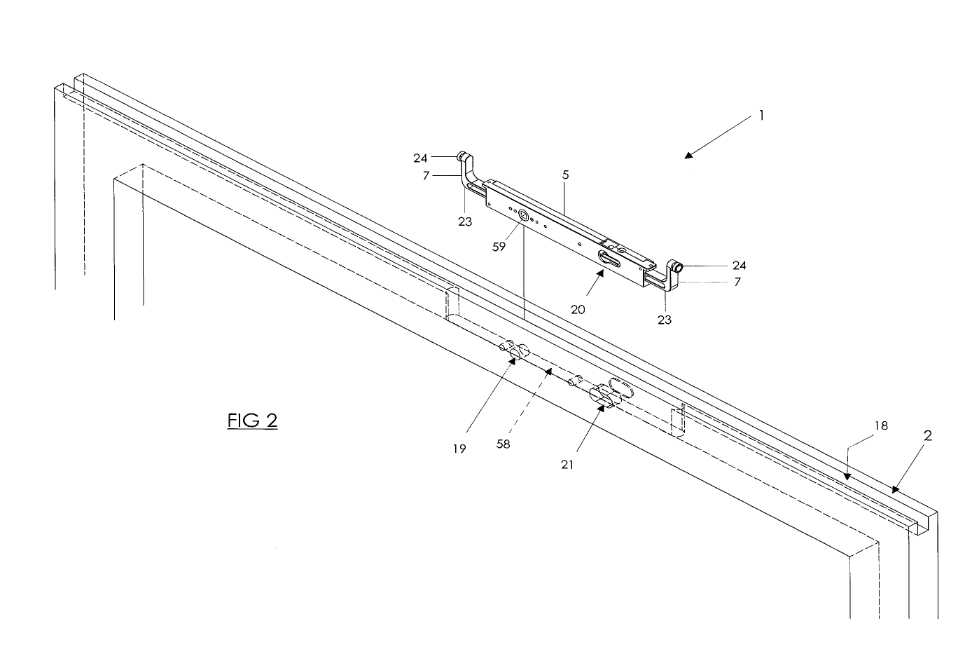

FIG. 2 illustrates a first step of constructing and installing the assembly 1 in the groove 2, where the handle mechanism 5 is introduced into a rebate 58 formed in a base 18 of the groove 2 so that a rotary coupling 59 aligns with a first aperture 19 and an opening 20 in the body 6 aligns with a second aperture 21.

The length of the rebate 58 is sufficient to accommodate movement of the linkages 7 in and out of the body 6 in a direction indicated by arrow 22. The linkages 7 include an elbow joint 23 and a socket 24. Movement of the linkages 7 in and out of the body 6 results in corresponding movement of the sockets 24 lengthwise of the groove 2.

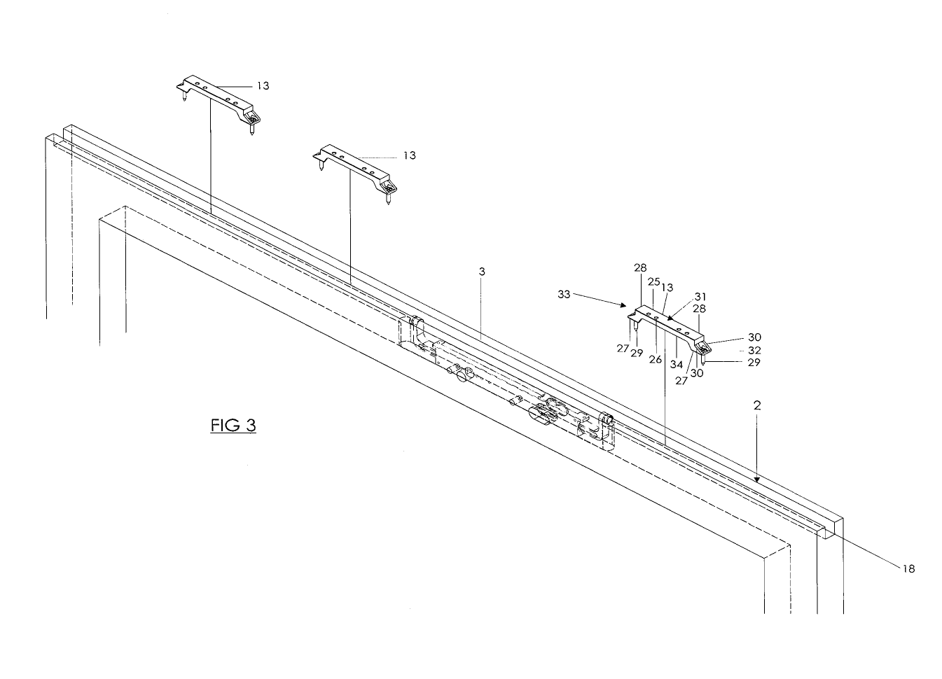

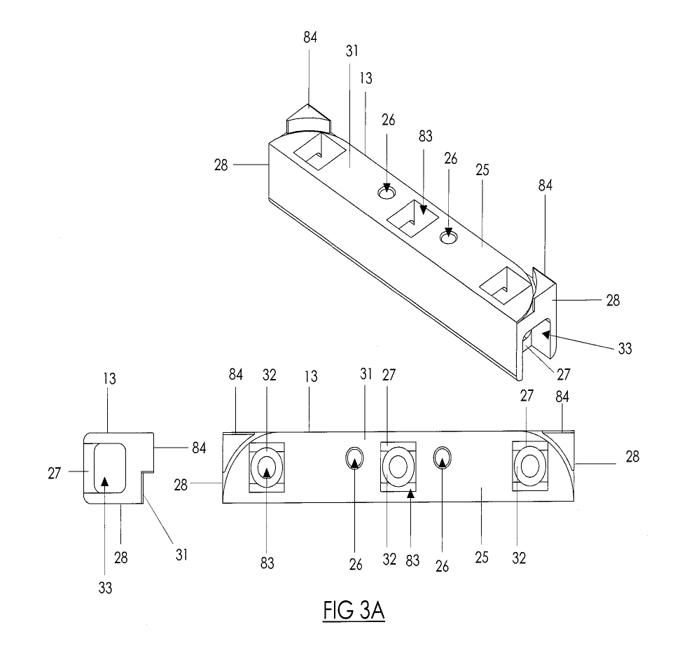

FIG. 3 shows the blocks 13 being fastened in the groove 2. Each block 13 includes an elevated deck 25 with attachment holes 26 and supporting platforms 27 that extend from either end 28 and are secured to the base 18 of the groove 2 with fasteners 29. The platforms 27 extend between side supports 30 and provide a seat 32 for the associated fastener 29. The platforms 27 are in spaced relation to the deck 25, in a direction of extent of the block 13, to allow clear access from a deck side 31 of the block 13 to screw the fastener 29 into the associated platform and the underlying base 18 of the groove 2.

The side supports 30 distance the deck 25 from the base 18 and define a passage 33 that extends the length of the block 13, beneath the underside 34 of the deck 25 and the platforms 27. When positioned in the groove 2, the deck 25 of each block 13 is substantially level with the side edge 3 of the panel 4.

An alternative form of hinge block 13 is shown in FIG. 3A where like parts are denoted with like reference numerals. A passage 33 again extends through the block 13 between the deck 25 and platforms 27, however, instead of projecting from ends 28 of the deck 25, the platforms 27 are instead located internally of the block 13, beneath the deck 25. Openings 83 are provided in the deck 25 to allow access to the platforms 27 so that fasteners (not shown) can he screwed into seats 32 provided in each platform 27, directly through the block 13 from a deck side 31 of the block 13. The block 13 also includes shoulders 84 that project above the level of the deck 25 to assist in locating the hinge over the attachment holes 26.

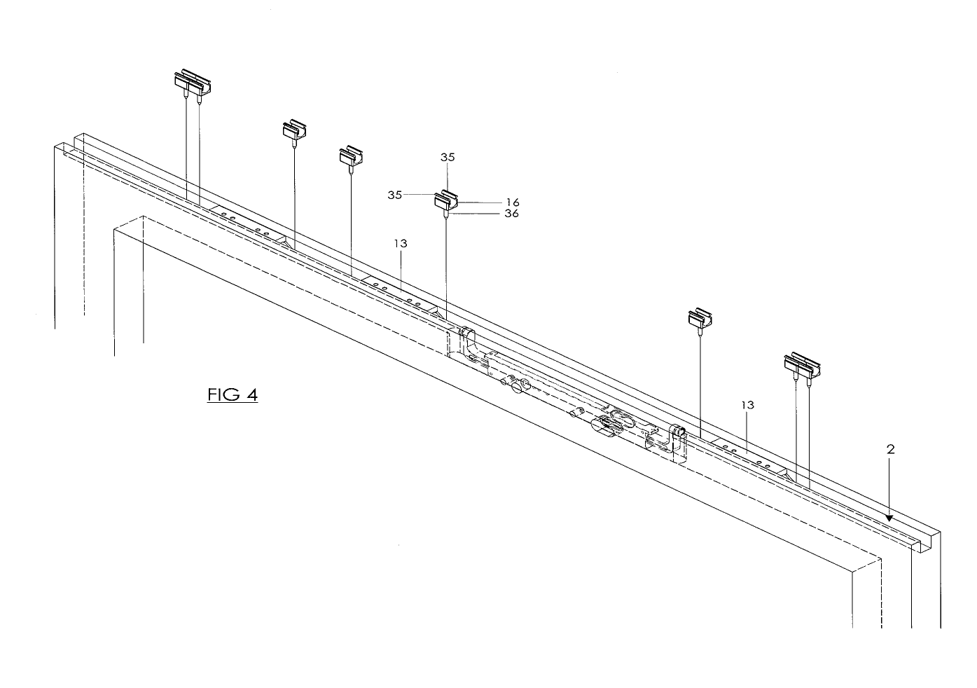

FIG. 4 illustrates the clips 16 being introduced into the groove 2. Each clip 16 is generally U-shaped with resilient fingers 35 and a fastening screw 36 to locate the clip 16 either side of an associated block 13. As mentioned above with reference to FIG. 1, the clips 16 serve a dual role of guiding the rods 11 while holding the cover strips 17. The resilient fingers 35 serve to hold the cover strips 17 in place.

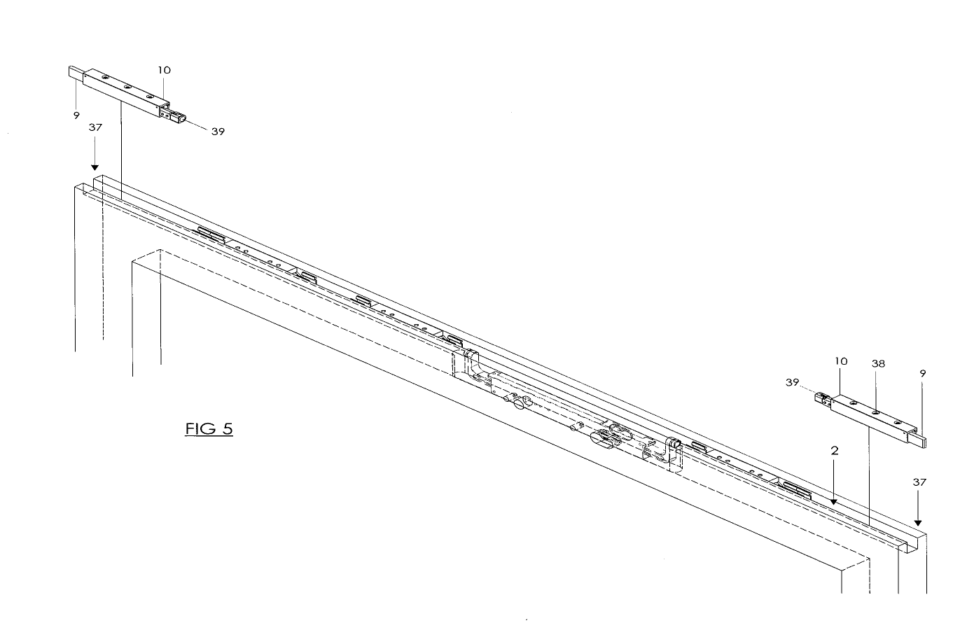

FIG. 5 shows the end cleats 10 being positioned in the ends 37 of the groove 2. Each cleat 10 includes through holes 38 for attaching the cleats 10 in the groove 2. The cleats 10 house the respective shoot bolts 9 that are arranged to slide lengthwise of the cleats 10. A socket 39 is connected to each shoot bolt 9.

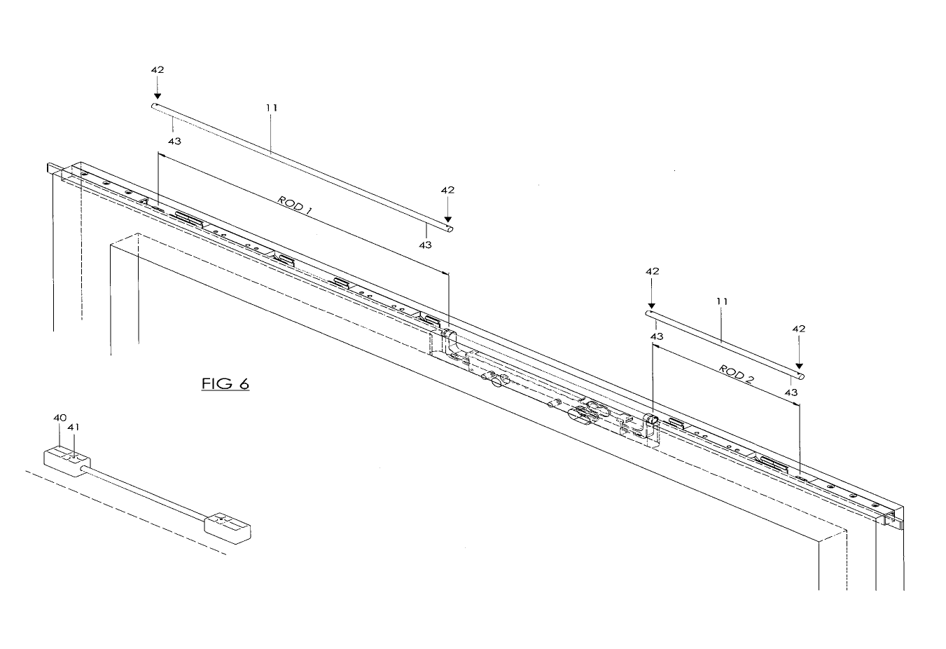

FIG. 6 shows installation of the rods 11 which are initially measured and cut to length. Prior to installation, the rods 11 are inserted in a drilling jig 40 whom a template 41 allows holes 42 to be drilled in either end 43 of the rods 11 so that each hole 42 is oriented in the same direction.

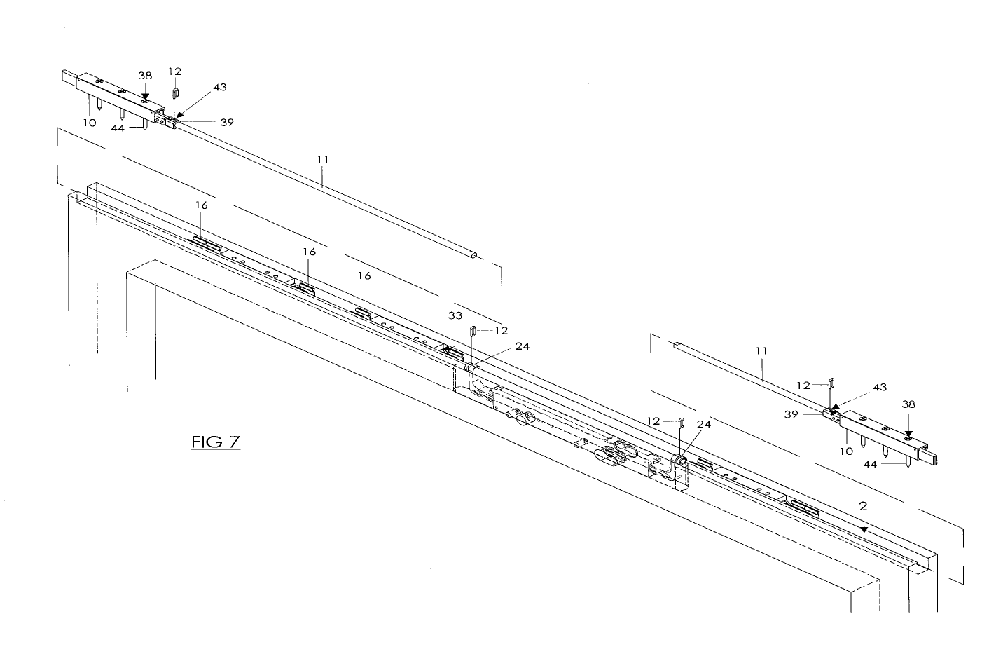

FIG. 7 shows the rods 11 being inserted in the sockets 39 of the shoot bolts 9 so that the holes 42 in the rods 11 align with holes 43 provide in the sockets 39 in order for the connectors 12 to lock the rods 11 and sockets 39 together. When the rods 11 are inserted through each of the clips 16 and passages 33 of the blocks 13, a similar retainer connector 12 allows the rods 11 and sockets 24 of the linkages 7 to be connected.

FIG. 7 also shows fasteners 44 in the holes 38 to secure the shoot bolt cleats 10 in the groove 2, once the rods 11 are connected.

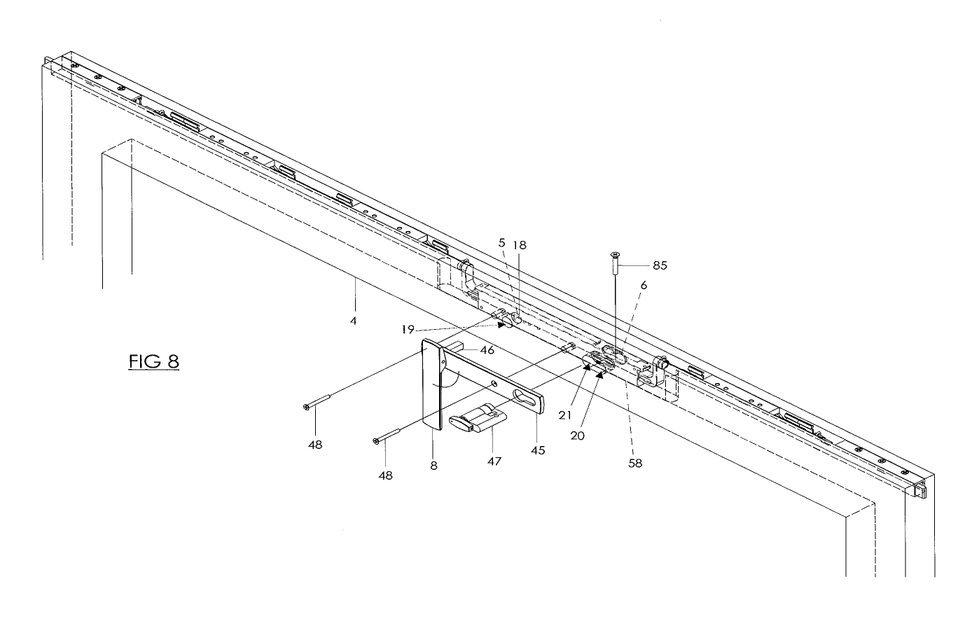

FIG. 8 shows the handle 8 and a cover plate 45 being mounted to the door panel 4. The handle 8 has a shall 46 that extends through the first aperture 19, to engage the rotary coupling 18. A lock barrel 47 is loaded into the opening 20 in the body 6, through the second aperture 21, and the cover plate 45. Two additional bolts 48 are provided to fix the handle mechanism 5 in the rebate 58. A further bolt 85 fixes the lock barrel 47 in position.

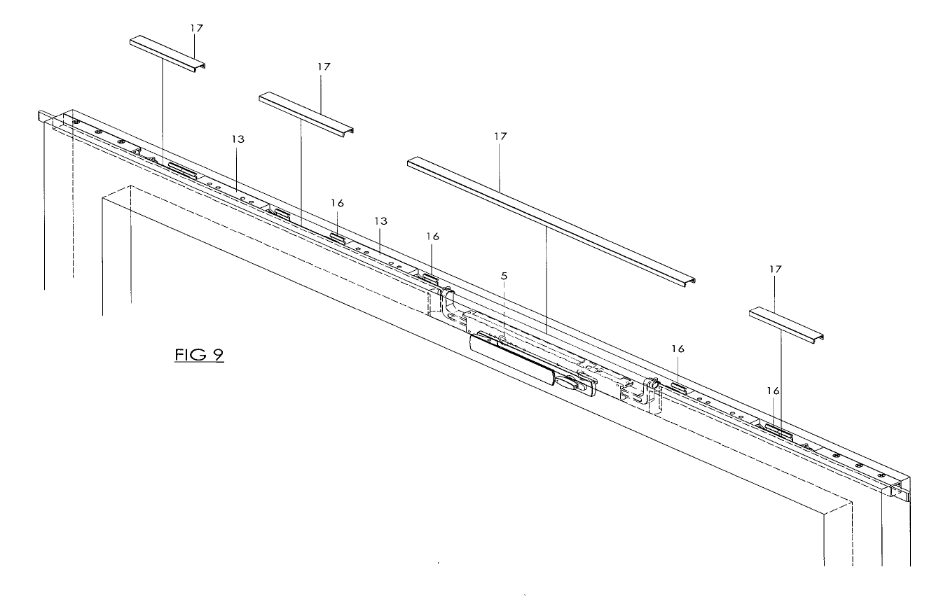

FIG. 9 shows the next step of assembly, where the cover strips 17 are snap fit onto the clips 16, between the respective blocks 13 and the further strip 17 is attached over the handle mechanism 5.

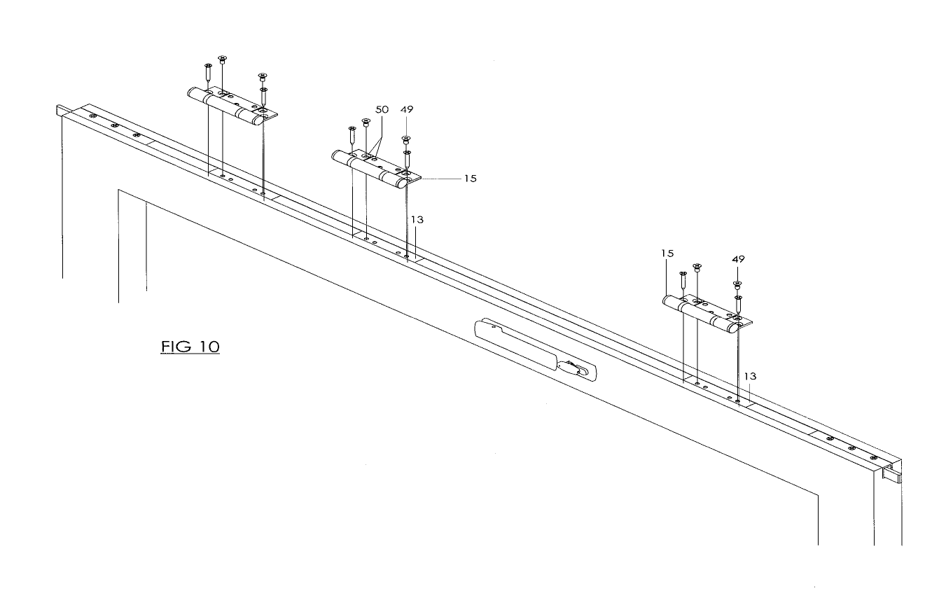

FIG. 10 illustrates the last stage of constructing the assembly 1, where the hinges 15 are attached to the blocks 13 using fasteners 49. The hinges 15 have pre-determined mounting holes 50 that align with the attachment holes 26 of the blocks 13.

FIG. 11 shows a hinge 15 attached to one of the blocks 13. The hinge 15 is a non-mortise hinge and includes a centre leaf 51 nested between two outer leaves 52. Holes 50 in both the outer leaves 52 and the centre leaf 51 align with the attachment holes 26 in the deck 25 so that either the centre leaf 51 or outer leaves 52 can be attached to the hinge 15, as required. FIG. 11c shows a fastener 49 that is screwed into the block 13 so that the hinge 15 can be securely anchored to the deck 25, while the passage 33 below the deck 25 remains clear for unobstructed movement of the rod 11 through the passage 33.

The interior face 53 of the panel 4 provides a datum point for the groove 2 and block 13, which in turn dictates the positioning of the attachment holes 26 so that the hinge 15 is located with the knuckle 54 of the hinge 15 in close proximity to the face 53 of the panel 4.

FIG. 12 shows a mortise hinge 15 with two large overlapping hinge leaves 55, 56. In this case, the interior face 53 of the panel 4 again provides a datum point for the knuckle 54 and positioning of the groove 2. However, the hinge leaves 55, 56 are wider and have a height dimension due to their stacked orientation so a recess 57 needs to be formed in the edge 3 of the panel 4 and a block 13, as described with reference to FIG. 3A, is used with a different configuration of attachment holes 26. In this case, the platforms 27 are internal of the block 13 and the raised shoulders 84 assist in locating the hinge 15 over the attachment holes 26.

FIG. 13 shows an interior view of a folding panel system 60 with a series of panels 61 arranged between an overhead track 62 and a sill 63. The panels 61 include a pivot panel 64, an intermediate panel 65, an inactive/end panel 66 and an active access panel 67. Pivot sets 68 mount the pivot panel 64 and the active panel 67 in the track 62 and a wheeled hanger 69 supports the intermediate and inactive/end panel 65, 66.

The shoot bolt assembly 1 is mounted in the edge 3 of the intermediate panel 66 adjacent the pivot panel 64.

As indicated above, the interior face 53 of the panel 4 is used as a datum point for the assembly 1. With reference to FIGS. 13c and 13d in particular, this results in the shoot bolts 9 projecting from top and bottom edges 70, 71 of the panel 4 at a fixed distance from the interior face 53, into respective keepers 72, 73 associated with the track 62 and sill 63. The sill 63 is in the form of an extruded profile 74 that defines a channel 75 for a bottom pivot 76 of the end panel 66 and an adjacent slot 77 that functions as the keeper 73 for the shoot bolt 9.

If a thicker panel 78 is used, such as shown in FIG. 14, the position of the shoot bolts 9 relative to the face 53 of the panel 78 will remain the same and the distance between the shoot bolts 9 and the track 62 and associated channel 75 increases, which means the position of the keepers 72, 73 relative to the track 62 and the channel 75 will change. FIG. 14a shows the increased distance between the keeper 72 and the track 62 while FIG. 14b shows a second pre-formed slot 79 in the profile 74, which is further from the channel 75, functioning as the keeper 73. As such, the same profile 74 is able to provide two differently positioned keepers 73 in order to accommodate the different width panel 78.

FIG. 15 shows another panel 80 of even greater width. In this case, the keepers 72, 73 for the top and bottom shoot bolts 9 are both separately mounted in a timber frame 81 adjacent the track 62 and sill 82.

It should be appreciated that since the interior face 53 of the panel 80 is used as the datum point for the assembly 1, the position of the groove 2, rods 11 and handle mechanism 5 within the panel 80 is the same, regardless of the width of the panel 80. This means all of the components of the assembly can be universally applied to different width panels, including the handle 8, lock barrel 47 and hinges 15. The only change required for door panel system 60 if different width panels are used, is for the keepers 72, 73 to be moved relative to the track 62 and channel 75 and a different sill profile 74 or an independently mounted keeper 73 may be needed if the profile 74 is not already configured to provide optional keeper positions.

As such, no changes are needed to the assembly 1 for use with different width panels. This is in marked contrast to the prior art where different hinges, handles and lock barrels would be needed.

It may also be appreciated the hinge blocks 13 of the invention provide an advantage of the prior art technique of simply screwing hinges on to the cover strips as the blocks 13 provide attachment holes 26 in predefined positions that allow hinges 15 to be secured to the decks 25 of the blocks 13 without interfering with the rods 11 that pass through passages 33 beneath the decks 25. This provides a considerable advantage compared to the prior art where operation of the rods could easily be fouled by fasteners being screwed into incorrect locations on the cover strips. Also, the hinge blocks 13 provide an additional function of reinforcing the edge 3 of the panel 4, which provides greater structural rigidity and strength to the panel edge 3 to compensate for any structural weakness introduced as a result of machining the groove 2 in the panel 4.

### LIST OR PARTS

1. Shoot bolt assembly

2. Groove

3. Side edge

4. Panel

5. Handle mechanism

6. Body

7. Linkage

8. Handle

9. Shoot bolt

10. End cleat

11. Rod

12. Connector

13. Hinge block

14. Hole

15. Hinge

16. Clip

17. Cover strip

18. Rotary coupling

19. Aperture

20. Opening

21. Aperture

22. Arrow

23. Elbow joint

24. Socket

25. Deck

26. Hole

27. Platform

28. End

29. Fastener

30. Support

31. Deck side

32. Seat

33. Passage

34. Underside

35. Finger

36. Screw

37. End

38. Hole

39. Socket

40. Jig

41. Template

42. Hole

43. Hole

44. Fastener

45. Cover plate

46. Shaft

47. Lock barrel

48. Bolt

49. Fastener

50. Hole

51. Centre leaf

52. Outer leaves

53. Interior face

54. Knuckle

55. Hinge leaf

56. Hinge leaf

57. Recess

58. Rebate

59. Rotary coupling

60. Folding panel system

61. Panels

62. Track

63. Sill

64. Pivot panel

65. Intermediate panel

66. End panel

67. Active panel

68. Pivot sets

69. Hanger

70. Top edge

71. Bottom edge

72. Keeper

73. Keeper

74. Profile

75. Channel

76. Bottom pivot

77. Slot

78. Panel

79. Slot

80. Panel

81. Frame

82. Sill

83. Openings

84. Shoulders

85. Bolt

1. A shoot bolt assembly for mounting in a groove formed in a side edge of a panel, the assembly including a handle mechanism, a shoot bolt and a rod to connect the handle mechanism to the shoot bolt so that actuation of the handle mechanism causes the shoot bolt to extend and retract from a top or bottom edge of the panel, wherein the assembly includes a hinge block arranged to fit in the groove, the hinge block having a deck with attachment holes for a hinge and fixing platforms that secure the block to a base of the groove, wherein a passage is provided beneath the deck and platforms for the rod to pass through.

2. The shoot bolt assembly of claim 1, wherein the block includes side supports that distance the deck from the platforms.

3. The shoot bolt assembly of claim 2, wherein the platforms bridge between the side supports and extend from either end of the deck, to receive a respective fastener to fix the platforms to the base of the groove.

4. The shoot bolt assembly of claim 2, wherein the platforms are located between the ends of the block and the deck has openings to allow access to the platforms, in order for the platforms to receive associated fasteners for fixing the block to the base of the groove.

5. The shoot bolt assembly of claim 1, further including clips that are fastened into the groove either side of the block to ensure alignment of the rod is maintained through the groove.

6. The shoot bolt assembly of claim 5, wherein the clips include resilient fingers to hold a cover strip.

7. The shoot bolt assembly claim 1, including multiple hinge blocks arranged along the groove at locations where hinges are positioned to connect the panel to an adjacent pivot panel.

8. The shoot bolt assembly of claim 1, including a second shoot bolt and an associated rod for attachment to the handle mechanism such that operation of the handle mechanism causes the first and second shoot bolts to simultaneously extend and retract from the respective top and bottom edges of the panel.

9. A hinge block for the shoot bolt assembly of claim 1, including a deck with attachment holes for a hinge and fixing platforms to mount the block in a groove in a side edge of a panel, with the deck in spaced relation from a base of the groove so as to define a passage beneath the deck.

10. The hinge block of claim 9, wherein the platforms bridge between side supports of the block and extend from either end of the deck, each platform having an aperture to receive a fastener to secure the block in the groove.

11. The hinge block of claim 9, wherein the platforms are located between ends of the block and the deck has openings to allow access to the platforms, in order for the platforms to receive associated fasteners for fixing the block to the base of the groove.

12. The hinge block of claim 11, wherein the block includes shoulders that project above a level of the deck in order to locate a hinge over the attachment holes.

13. A folding panel system including a series of panels mounted between an overhead track and a sill, wherein two of the panels are hinged together and the shoot bolt assembly of claim 1 is mounted in a side edge of one of the panels.

14. A method of constructing a panel with a groove formed in a side edge of the panel and the shoot bolt assembly of claim 1, including:
mounting the handle mechanism in a rebate formed in a base of the groove;
fixing the hinge block in the groove so the deck is substantially level with the side edge;
inserting a rod through the passage beneath the deck; and
attaching ends of the rod to the handle mechanism and the shoot bolt.

15. The method of claim 14, further including attaching a hinge to the hinge block by screwing fasteners into the deck.

16. The method of claim 15, wherein multiple hinge blocks are fixed along the groove, at locations where hinges are positioned to connect the panel to an adjacent panel.

17. The method of claim 16, further including inserting a second rod in the channel, from an opposite side of the handle mechanism, passing the second rod through one or more of the multiple hinge blocks and attaching ends of the second rod to the handle mechanism and a second shoot bolt.

18. The method of claim 17, wherein clips are fixed into the groove, either side of the cleats in order to maintain alignment of the rods in the groove.

19. The method of claim 18, wherein cover strips are fitted over the groove and held in place by resilient fingers of the clips.

20. The method of claim 14, wherein an interior face of the panel is used as a datum point for determining the relative position of the shoot bolt assembly.
